(19) United States
(12) Patent Application Publication
(10) Pub. No.: US 2026/0233401 A1
(43) Pub. Date: Aug. 13, 2026

(54) Information Processing Device, Collaborative Robot, and Method for Supporting Load Setting

(71) Applicant: DMG MORI CO., LTD., NARA (JP)

(72) Inventors: Hideki NAGASUE, NARA (JP); Munetaka WAKIZAKA, NARA (JP); Yuta NABETA, NARA (JP); Ryota MAEDA, NARA (JP); Yasunori SUZUKI, NARA (JP); Mutsumi ITO, NARA (JP)

(73) Assignee: DMG MORI CO., LTD., NARA (JP)

(21) Appl. No.: 19/536,540

(22) Filed: Feb. 11, 2026

(30) Foreign Application Priority Data
Feb. 12, 2025 (JP) 2025-020854
Feb. 12, 2025 (JP) 2025-020857

(51) Int. Cl. B25J 9/16

(52) U.S. Cl. CPC B25J 9/1689; B25J 9/1666

(57) ABSTRACT

An information processing device supports load setting in a collaborative robot having a plurality of axes driven by motors, and includes: a display; display control means for causing the display to selectively display a plurality of operation screens for the load setting; and communication means for communicating with the collaborative robot. Each of the plurality of operation screens is associated with a corresponding one of a plurality of predetermined postures of the collaborative robot, the corresponding ones being different from each other. Each of the operation screens includes: a first button for instructing the collaborative robot, via the communication means, to transition to the posture associated with the operation screen; a second button for instructing the collaborative robot, via the communication means, to open/close a hand that grips a workpiece; and a third button for instructing the collaborative robot, via the communication means, to measure current values of the motors.

### CROSS REFERENCE TO RELATED APPLICATIONS

This nonprovisional application is based on Japanese Patent Application No. 2025-020854 filed on Feb. 12, 2025, and No. 2025-020857 filed on Feb. 12, 2025, with the Japan Patent Office, the entire contents of which are hereby incorporated by reference.

### BACKGROUND OF THE INVENTION

### Field of the Invention

The present disclosure relates to an information processing device, a collaborative robot, and a method for supporting load setting.

### Description of the Background Art

Conventionally, as disclosed in Japanese Patent No. 7311732, in a collaborative robot, it is necessary to preset information on a load such as a tool attached to the collaborative robot and a workpiece gripped by the tool (for example, the mass of the load, the position of the center of gravity of the load, the inertia moment of the load, and the like), in order to accurately measure a contact force of the collaborative robot.

### SUMMARY OF THE INVENTION

When the information on the load such as the workpiece is set, the following user operation is required. First, a user transitions the collaborative robot to one of a plurality of designated postures (positions). Then, the user causes a gripper (for example, a hand) of the collaborative robot to grip a predetermined position of the workpiece. In this state, the user causes the collaborative robot to measure current values of motors that operate links of the collaborative robot. Finally, the user provides the collaborative robot with an instruction for removing the workpiece. The user needs to perform a series of processing including the four operations as described above, for each of the plurality of designated postures.

Accordingly, if a program for displaying a screen for changing the posture of the collaborative robot, a program for displaying a screen for instructing measurement of the current values, and a program for displaying a screen for instructing grip and removal of the workpiece are different, the user needs to switch a program to be used to another one, three times for each posture. Therefore, the user’s time and effort are required.

The present disclosure provides an information processing device, a collaborative robot, and a method for supporting load setting that can reduce time and effort for a user operation during the load setting.

According to an aspect of the present disclosure, an information processing device supports load setting in a collaborative robot having a plurality of axes driven by motors different from each other. The information processing device includes: a display; display control means for causing the display to selectively display a plurality of first operation screens for the load setting; and communication means for communicating with the collaborative robot. Each of the plurality of first operation screens is associated with a corresponding one of a plurality of predetermined postures of the collaborative robot, the corresponding ones being different from each other. Each of the first operation screens includes: a first button for instructing the collaborative robot, via the communication means, to transition to the posture associated with the first operation screen; a second button for instructing the collaborative robot, via the communication means, to open/close a hand that grips a workpiece; and a third button for instructing the collaborative robot, via the communication means, to measure current values of the motors.

According to another aspect of the present disclosure, an information processing device supports load setting in a collaborative robot having a plurality of axes driven by motors different from each other. The information processing device includes: communication means for communicating with the collaborative robot; first instruction means for instructing the collaborative robot, via the communication means, to transition to a predetermined posture; second instruction means for instructing the collaborative robot, via the communication means, to open/close a hand that grips a workpiece; and third instruction means for instructing the collaborative robot, via the communication means, to measure current values of the motors.

According to still another aspect of the present disclosure, a collaborative robot includes: a hand that grips a workpiece; a plurality of axes including an axis that opens/closes the hand; a plurality of motors that individually drive the plurality of axes; a plurality of sensors that individually detect current values of currents flowing through the plurality of motors; control means for controlling the plurality of motors; and communication means for communicating with an information processing device. When the control means receives a first instruction from the information processing device via the communication means, the control means transitions a posture of the collaborative robot to a predetermined posture. When the control means receives a second instruction from the information processing device via the communication means, the control means opens/closes the hand. When the control means receives a third instruction from the information processing device via the communication means, the control means acquires the current values of the plurality of motors from the plurality of sensors.

According to still another aspect of the present disclosure, a method for supporting load setting in a collaborative robot having a plurality of axes driven by motors different from each other includes: selectively displaying a plurality of operation screens for the load setting; and communicating with the collaborative robot. Each of the plurality of operation screens is associated with a corresponding one of a plurality of predetermined postures of the collaborative robot, the corresponding ones being different from each other. Each of the operation screens includes a first button for instructing the collaborative robot to transition to the posture associated with the operation screen, a second button for instructing the collaborative robot to open/close a hand that grips a workpiece, and a third button for instructing the collaborative robot to measure current values of the motors. The method for supporting the load setting further includes receiving selection of the first to third buttons on each of the operation screens.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a robot system.

FIG. 2 is a diagram showing a simplified structure of a robot main body portion.

FIG. 3 is a block diagram for further illustrating a configuration of a collaborative robot and a tablet terminal.

FIG. 4 is a diagram showing an operation screen displayed on the tablet terminal.

FIG. 5 is a diagram showing another operation screen displayed on the tablet terminal.

FIG. 6 is a diagram showing still another operation screen displayed on the tablet terminal.

FIG. 7 is a flowchart for illustrating an operation order of a plurality of buttons, and an operation of the collaborative robot when each button is selected.

FIG. 8 is a diagram showing still another operation screen displayed on the tablet terminal.

FIG. 9 is a diagram showing an operation screen for changing a load setting number.

### DESCRIPTION OF THE PREFERRED EMBODIMENTS

Hereinafter, an embodiment according to the present invention will be described with reference to the drawings. In the following description, identical parts and components will be designated by the same reference numerals. Since their names and functions are also the same, the detailed description thereof will not be repeated. It should be noted that, in the following, the "position" of a robot means the "posture" of the robot. The position includes information on a rotation angle of each axis described later.

### A. Overview of Robot System

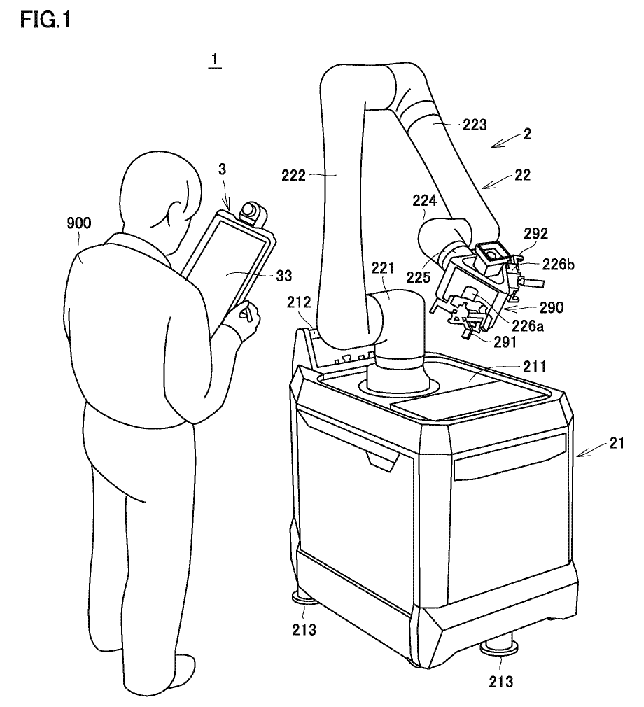

FIG. 1 is a diagram showing a robot system in the present embodiment. As shown in FIG. 1, a robot system 1 includes a collaborative robot 2 and a tablet terminal (an information processing device) 3.

In the present example, collaborative robot 2 is a robot cart pushed by hand. Collaborative robot 2 includes a cart portion 21 and a robot main body portion 22. Cart portion 21 includes a top surface portion 211, a grip portion 212, a plurality of position fixing members 213, and running wheels (not shown). Grip portion 212 is a portion to be gripped by a user when the user moves collaborative robot 2 to another location, for example. Each position fixing member 213 is a member that restricts movement of cart portion 21.

Tablet terminal 3 communicates with collaborative robot 2. Tablet terminal 3 includes a touch screen 33. Tablet terminal 3 is operated by a user (an operator) 900 who performs teaching on collaborative robot 2. While online teaching and direct teaching using tablet terminal 3 are assumed in the present example, the teaching method is not limited thereto.

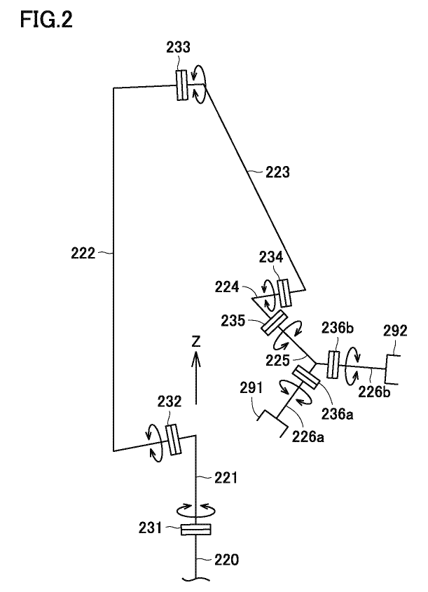

FIG. 2 is a diagram showing a simplified structure of robot main body portion 22. As shown in FIGS. 1 and 2, in the present example, collaborative robot 2 (specifically, robot main body portion 22) is a six-axis articulated robot. Specifically, collaborative robot 2 is a vertical articulated robot having six degrees of freedom.

Robot main body portion 22 includes an end effector 290 as a tool. In the present example, end effector 290 is a gripper. Specifically, end effector 290 has a hand. In the present example, opening/closing of the hand is performed by a motor. The present invention is not limited thereto, and opening/closing of the hand may be performed by air pressure. It should be noted that end effector 290 may use a pneumatic or magnet suction head, instead of a hand.

End effector 290 has two hands 291 and 292. Hand 291 and hand 292 face directions different from each other. It should be noted that, in the following, hand 291 is also referred to as a "hand #1", and hand 292 is also referred to as a "hand #2".

Robot main body portion 22 is installed on top surface portion 211. Robot main body portion 22 includes a first axis (joint) 231, a second axis (joint) 232, a third axis (joint) 233, a fourth axis (joint) 234, and a fifth axis (joint) 235. Furthermore, since robot main body portion 22 includes two hands 291 and 292, robot main body portion 22 further includes a first sixth axis (joint) 236a and a second sixth axis (joint) 236b.

Robot main body portion 22 further includes links 220 to 225, 226a, and 226b. Each link is a part of an arm. Link 220 is located below first axis 231. Link 220 is connected to cart portion 21 and first axis 231. Link 221 is connected to first axis 231 and second axis 232.

Similarly, link 222 is connected to second axis 232 and third axis 233. Link 223 is connected to third axis 233 and fourth axis 234. Link 224 is connected to fourth axis 234 and fifth axis 235. Link 225 is connected to fifth axis 235 and sixth axes 236a and 236b.

Links 226a and 226b are links within end effector 290. Link 226a is connected to first sixth axis 236a and hand 291. Link 226b is connected to second sixth axis 236b and hand 292.

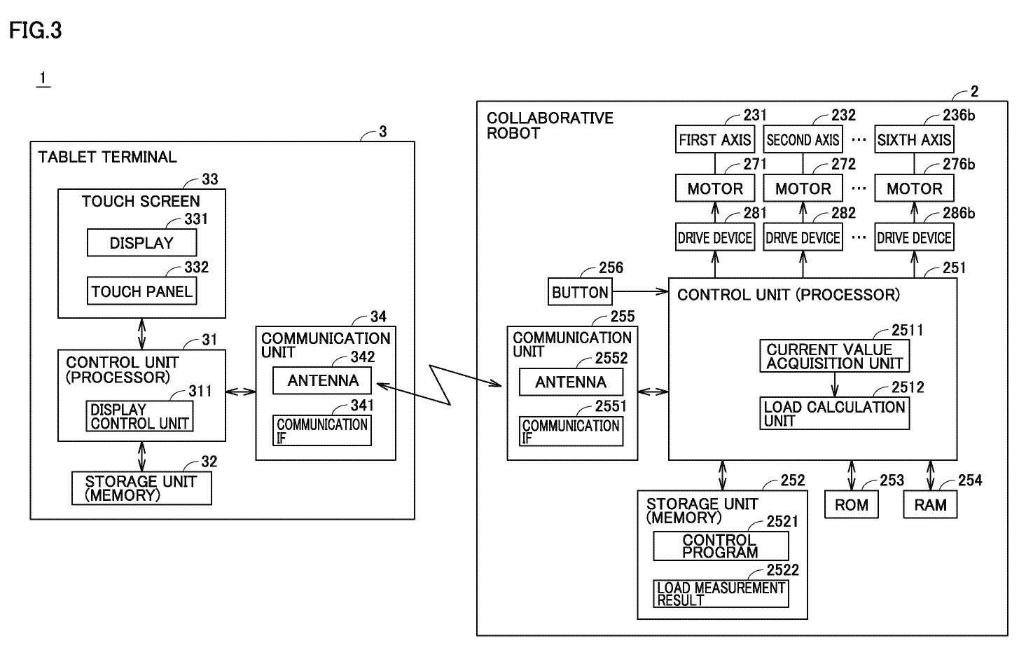

Robot main body portion 22 includes, for each of seven first to sixth axes 231 to 236b, a motor that drives each axis (see FIG. 3). When the motor is driven, each axis (joint) moves. It should be noted that, in the present example, a servo motor is used as the motor. Thus, in collaborative robot 2 (specifically, robot main body portion 22), a plurality of axes (the first to sixth axes) are driven by motors different from each other.

FIG. 3 is a block diagram for further illustrating a configuration of collaborative robot 2 and tablet terminal 3. As shown in FIG. 3, collaborative robot 2 includes seven motors 271, 272, 273, 274, 275, 276a, and 276b, and seven drive devices 281, 282, 283, 284, 285, 286a, and 286b, in addition to seven first to sixth axes 231 to 235, 236a, and 236b described above. It should be noted that motors 273, 274, 275, and 276a and drive devices 283, 284, 285, and 286a are not shown in FIG. 3. Collaborative robot 2 further includes a control unit 251, a storage unit 252, a read only memory (ROM) 253, a random access memory (RAM) 254, a communication unit 255, and a button 256.

Control unit 251 includes a current value acquisition unit 2511 and a load calculation unit 2512. Storage unit 252 stores a control program 2521. A load measurement result 2522 is stored in storage unit 252. Communication unit 255 includes a communication interface (IF) 2551 and an antenna 2552.

Control unit 251 controls an overall operation of collaborative robot 2. Control unit 251 is a functional block implemented by a processor executing various programs such as control program 2521.

Drive device 281 drives motor 271 based on a command from control unit 251. First axis 231 is driven by driving of motor 271. Similarly, drive devices 282 to 286b drive motors 272 to 276b, respectively. Second to sixth axes 231 to 236b are driven by driving of motors 272 to 276b.

Button 256 is provided on a surface of cart portion 21. Button 256 is a physical button to be operated (pressed in the present example) by user 900. An aspect of using button 256 will be described below.

Communication unit 255 performs communication with tablet terminal 3. Communication IF 2551 transmits radio waves via antenna 2552. Communication IF 2551 transmits radio waves received by antenna 2552 to control unit 251.

Collaborative robot 2 further includes a plurality of sensors (not shown) that senses values of currents flowing through motors 271 to 276b, respectively. It should be noted that processing in current value acquisition unit 2511 and processing in load calculation unit 2512 will be described later. Load measurement result 2522 will also be described later.

Tablet terminal 3 includes a control unit 31, a storage unit 32, and a communication unit 34, in addition to touch screen 33 described above. Control unit 31 includes a display control unit 311. Communication unit 34 includes a communication IF 341 and an antenna 342. Touch screen 33 includes a display 331 and a touch panel 332.

Control unit 31 controls an overall operation of tablet terminal 3. Control unit 31 is a functional block implemented by a processor executing various programs stored in storage unit 32 and the like. By a touch operation of user 900 on touch panel 332, an input is notified to control unit 31. Display control unit 311 controls display on display 331.

Communication unit 34 performs communication with collaborative robot 2. Communication IF 341 transmits radio waves via antenna 342. Communication IF 341 transmits radio waves received by antenna 342 to control unit 31.

### B. Setting of Load Information

Hereinafter, setting of load information for a workpiece (specifically, setting and registration with collaborative robot 2) will be described. Examples of the load information for the workpiece include the mass of the workpiece, the position of the center of gravity of the workpiece, and the inertia moment (inertia) of the workpiece. Specifically, the load information for the workpiece is individually set in a case where the workpiece is in the state of a material, and in a case where the workpiece is a finished product manufactured by processing the material.

When setting the load information for the workpiece, user 900 performs the following processing. First, user 900 transitions collaborative robot 2 to one of a plurality of (four in the present example) designated positions. In the present example, although details will be described later, user 900 automatically transitions collaborative robot 2, without using a tool (program) for designating coordinates such as a jog dial. Then, user 900 causes hand 291 (or hand 292) of collaborative robot 2 to grip a predetermined position of the workpiece. In this state, the user causes collaborative robot 2 to measure the current values of motors 271 to 276b that operate links 221 to 226b of collaborative robot 2. Finally, the user provides collaborative robot 2 with an instruction for removing the workpiece.

User 900 performs a series of processing including the four operations as described above, for each of the plurality of designated positions. At each position, the current values of the motors that operate six axes are measured. For example, in load measurement using hand 291, the current values of six motors 271 to 275 and 276a are measured by the sensors. Current value acquisition unit 2511 acquires the six measured current values.

Hereinafter, a method for setting the load information will be specifically described, based on screens displayed on tablet terminal 3. It should be noted that, in the following, for convenience of description, "setting of the load information" is also referred to as "load setting".

### b1. Operation Screen G1

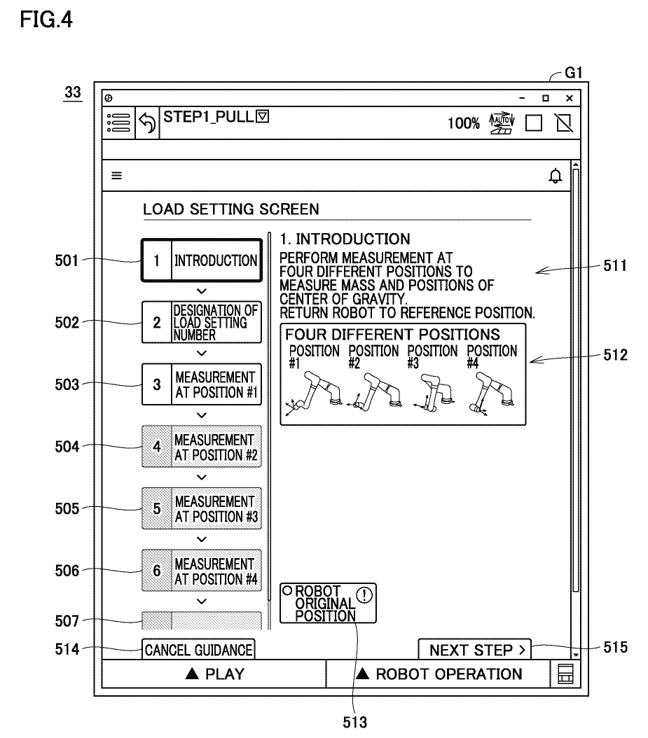

FIG. 4 is a diagram showing an operation screen G1 displayed on tablet terminal 3. Operation screen G1 and other operation screens described later are screens to be displayed when the load setting is performed.

As shown in FIG. 4, operation screen G1 includes image objects 501 to 507 arranged in one vertical line. Image objects 501 to 507 show outlines of processing and a processing order. Operation screen G1 is a screen corresponding to image object 501.

Since the displayed screen is operation screen G1, tablet terminal 3 sets a manner of display of image object 501 to a manner of display that is different from a default manner of display. Specifically, tablet terminal 3 highlights image object 501. In the present example, tablet terminal 3 displays image object 501 such that the periphery (boundary portion) thereof has a specific color and thickness.

Operation screen G1 further includes a descriptive text 511 describing an operation. Operation screen G1 includes an image 512 indicating four positions #1 to #4 (specifically, four designated postures) for transition at the time of the load setting.

Operation screen G1 further includes a button 513 for automatically returning collaborative robot 2 to an original position, a button 514 for selecting cancellation of guidance, and a button 515 for proceeding to the next step. It should be noted that, when button 514 is selected, the screen for the load setting is hidden.

User 900 selects button 513 on operation screen G1. When button 513 is selected, tablet terminal 3 instructs collaborative robot 2 to transition to the original position (a predetermined initial posture). After receiving the instruction, collaborative robot 2 returns the position to the original position, based on user 900 pressing button 256 (FIG. 3) of the collaborative robot. Thereafter, user 900 selects button 515 on operation screen G1. When button 515 is selected, tablet terminal 3 switches the operation screen from operation screen G1 to an operation screen G2.

### b2. Operation Screen G2

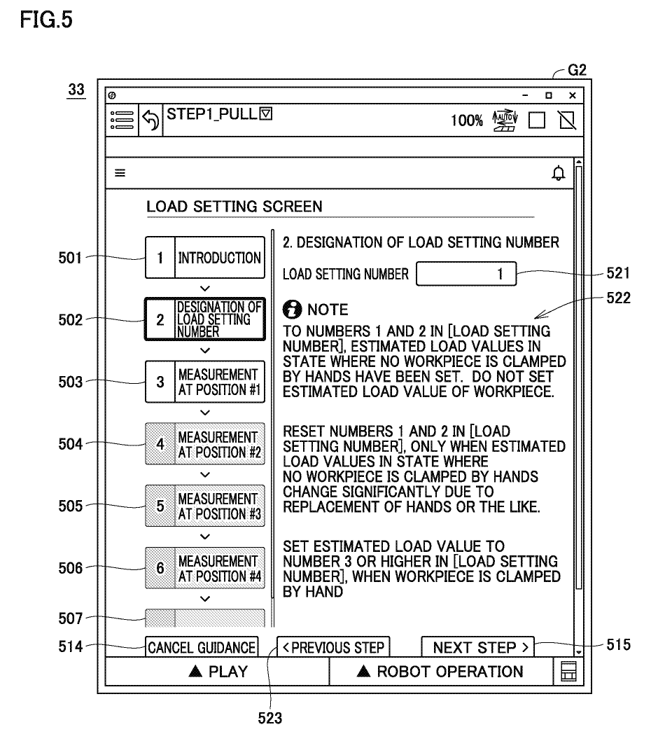

FIG. 5 is a diagram showing operation screen G2 displayed on tablet terminal 3. As shown in FIG. 5, operation screen G2 includes image objects 501 to 507 arranged in one vertical line, as with operation screen G1. Operation screen G2 is a screen corresponding to image object 502.

Since the displayed screen is operation screen G2, tablet terminal 3 sets a manner of display of image object 502 to a manner of display that is different from the default manner of display. Tablet terminal 3 highlights image object 502.

Operation screen G2 further includes an input field 521 for registering a load setting number, and a descriptive text 522 describing an operation. Operation screen G2 further includes button 514 for selecting cancellation of guidance, button 515 for proceeding to the next step, and a button 523 for returning to the previous step. It should be noted that, when button 523 is selected, tablet terminal 3 returns the operation screen from operation screen G2 to operation screen G1 (FIG. 4).

It should be noted that load setting numbers 1 and 2 are load setting numbers when the hands do not grip a workpiece. That is, numbers 1 and 2 are numbers set when only end effector 290 serves as a load. Therefore, in the present example, number 3 or higher is inputted as a load setting number in input field 521.

After inputting the load setting number, user 900 selects button 515 on operation screen G2. When button 515 is selected, tablet terminal 3 switches the operation screen from operation screen G2 to an operation screen G3.

### b3. Operation Screen G3

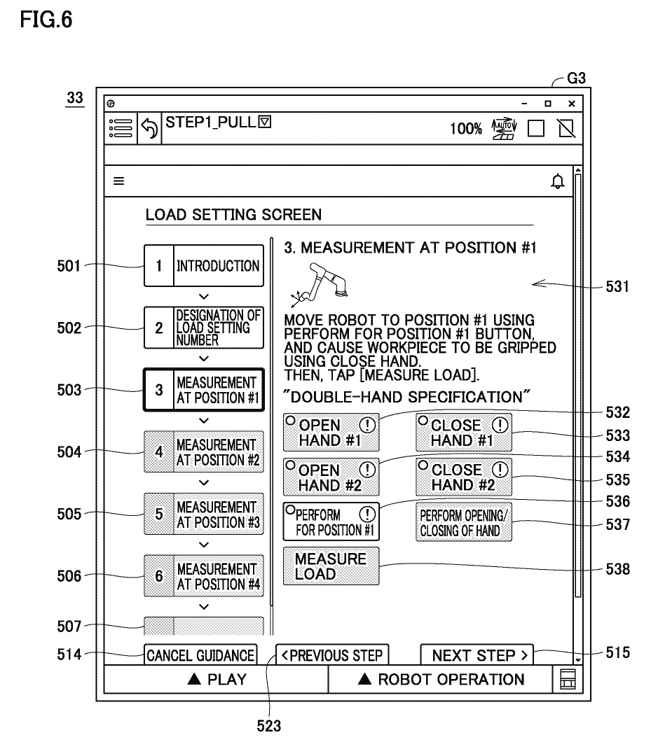

FIG. 6 is a diagram showing operation screen G3 displayed on tablet terminal 3. As shown in FIG. 6, operation screen G3 includes image objects 501 to 507 arranged in one vertical line, as with operation screens G1 and G2. Operation screen G3 is a screen corresponding to image object 503. Therefore, tablet terminal 3 sets a manner of display of image object 503 to a manner of display that is different from the default manner of display. Tablet terminal 3 highlights image object 503. It should be noted that operation screen G3 is a screen for double hands.

Operation screen G3 is associated with a corresponding one of a plurality of predetermined positions of the collaborative robot. Specifically, operation screen G3 is associated with position #1 of four positions #1 to #4. Operation screen G3 includes information 531 for describing measurement at position #1. Information 531 includes a robot image showing position #1, and a descriptive text. Operation screen G3 includes a plurality of buttons 532 to 538.

Buttons 532 to 535 and 537 are buttons related to the hands. Specifically, buttons 532 to 535 and 537 are buttons for instructing collaborative robot 2, via communication unit 34, to open/close hand #1 or hand #2 that grips a workpiece. Specifically, buttons 532 and 533 are buttons related to hand #1 (hand 291). Buttons 534 and 535 are buttons related to hand #2 (hand 292). Button 537 is a button related to hand #1 and hand #2.

Button 536 is a button for instructing collaborative robot 2, via communication unit 34, to transition to position #1 (a first posture) associated with operation screen G3. Button 538 is a button for instructing collaborative robot 2, via communication unit 34, to measure the current values of motors 271 to 275, 276a, and 276b.

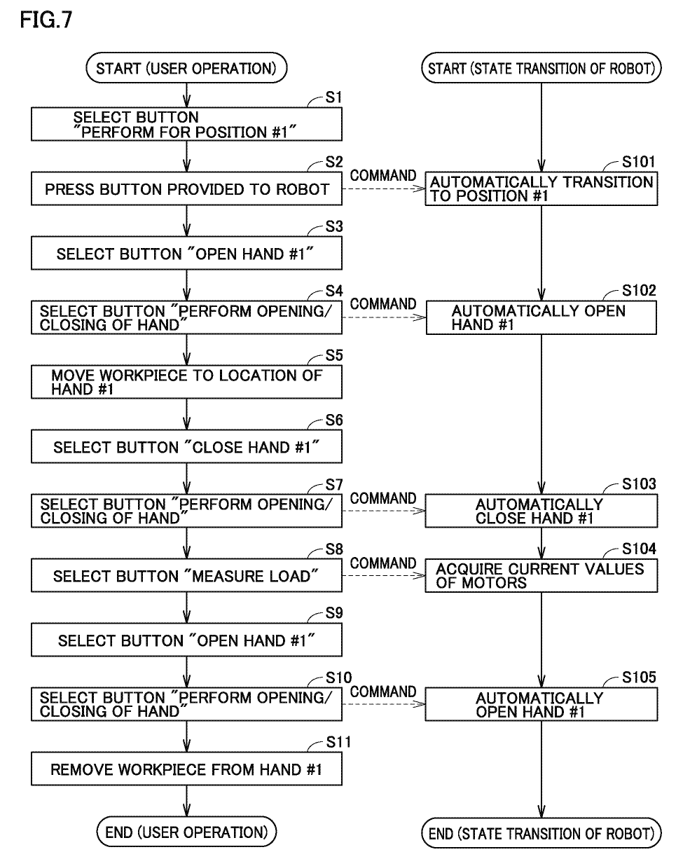

FIG. 7 is a flowchart for illustrating an operation order of buttons 532 to 538, and an operation of collaborative robot 2 when each of buttons 532 to 538 is selected. It should be noted that FIG. 7 shows processing focusing on hand #1.

As shown in FIG. 7, user 900 selects button 536 "PERFORM FOR POSITION #1" (step S1). When button 536 is selected, tablet terminal 3 transmits information on position #1 (information on the posture) and a command to transition to position #1, to collaborative robot 2. It should be noted that the information on position #1 is stored beforehand in storage unit 32 of tablet terminal 3. Information on position #2, information on position #3, and information on position #4, which will be described later, are also stored beforehand in storage unit 32.

Then, user 900 selects button 256 (FIG. 3) provided to collaborative robot 2 (step S2). When button 256 is selected, control unit 251 of collaborative robot 2 transitions the position of robot main body portion 22 from the original position to position #1, based on the information on position #1 (step S101). Thus, in the present example, transition of collaborative robot 2 to position #1 requires not only reception of the information on position #1 and the command to transition to position #1, but also selection of button 256, from the viewpoint of preventing an erroneous operation.

In a state where the position of collaborative robot 2 is set to position #1, user 900 selects button 532 "OPEN HAND #1" (step S3). Thereafter, user 900 selects button 537 "PERFORM OPENING/CLOSING OF HAND" (step S4). Thereby, tablet terminal 3 transmits a command to set hand #1 (hand 291) to an opened state, to collaborative robot 2. Based on the command, control unit 251 of collaborative robot 2 drives motor 276a. Thereby, hand #1 transitions to the opened state (step S102).

Then, in order to cause hand #1 to grip a workpiece, user 900 moves the workpiece to the location of hand #1 (step S5). Thereafter, user 900 selects button 533 "CLOSE HAND #1" (step S6). Thereafter, user 900 selects button 537 "PERFORM OPENING/CLOSING OF HAND" (step S7). Thereby, tablet terminal 3 transmits a command to set hand #1 (hand 291) to a closed state, to collaborative robot 2. Based on the command, control unit 251 of collaborative robot 2 drives motor 276a. Thereby, hand #1 transitions from the opened state to the closed state (step S103). As a result, the workpiece is gripped by hand #1.

In a state where the workpiece is gripped by hand #1, user 900 selects button 538 "MEASURE LOAD" (step S8). Thereby, tablet terminal 3 transmits a predetermined command to collaborative robot 2. Upon receiving the command, collaborative robot 2 measures the current values of the currents flowing through motors 271 to 275 and 276a, and stores a result of the measurement in association with the information on position #1 (step S104).

Then, user 900 selects button 532 "OPEN HAND #1" (step S9). Thereafter, user 900 selects button 537 "PERFORM OPENING/CLOSING OF HAND" (step S10). Typically, user 900 selects button 537 with a part of the workpiece being gripped. Thereby, tablet terminal 3 transmits a command to set hand #1 (hand 291) to the opened state, to collaborative robot 2. Thereby, hand #1 transitions to the opened state (step S105). User 900 can remove the workpiece from hand #1 (step S11).

Through a series of operations shown in FIG. 7, collaborative robot 2 can acquire the current values of motors 271 to 275 and 276a at position #1 related to hand #1.

Referring to FIG. 6 again, operation screen G3 further includes button 514 for selecting cancellation of guidance, button 515 for proceeding to the next step, and button 523 for returning to the previous step. It should be noted that, when button 523 is selected, tablet terminal 3 returns the operation screen from operation screen G3 to operation screen G2 (FIG. 5).

After removing the workpiece from hand #1, user 900 selects button 515 on operation screen G3. When button 515 is selected, tablet terminal 3 switches the operation screen from operation screen G3 to an operation screen G4 (not shown).

### b4. Operation Screens G4 to G6

Hereinafter, differences between operation screen G4 and operation screen G3 will be described. Operation screen G4 is a screen corresponding to image object 504. Therefore, tablet terminal 3 highlights image object 504. Operation screen G4 is associated with position #2 of four positions #1 to #4. Operation screen G4 includes information for describing measurement at position #2, instead of information 531. The information includes a robot image showing position #2, and a descriptive text.

Also on operation screen G4, user 900 performs a series of operations shown in steps S1 to S11 of FIG. 7. Thereby, control unit 251 (specifically, current value acquisition unit 2511) of collaborative robot 2 acquires the current values of motors 271 to 275 and 276a at position #2 related to hand #1. Control unit 251 stores a measurement result of the current values in association with the information on position #2.

After removing the workpiece from hand #1, the user selects button 515 on operation screen G4. When button 515 is selected, tablet terminal 3 switches the operation screen from operation screen G4 to an operation screen G5 (not shown).

Similarly, differences between operation screen G5 and operation screen G3 will be described. Operation screen G5 is a screen corresponding to image object 505. Therefore, tablet terminal 3 highlights image object 505. Operation screen G5 is associated with position #3 of four positions #1 to #4. Operation screen G5 includes information for describing measurement at position #3, instead of information 531. The information includes a robot image showing position #3, and a descriptive text.

Also on operation screen G5, user 900 performs a series of operations shown in steps S1 to S11 of FIG. 7. Thereby, control unit 251 (specifically, current value acquisition unit 2511) of collaborative robot 2 acquires the current values of motors 271 to 275 and 276a at position #3 related to hand #1. Control unit 251 stores a measurement result of the current values in association with the information on position #3.

After removing the workpiece from hand #1, the user selects button 515 on operation screen G5. When button 515 is selected, tablet terminal 3 switches the operation screen from operation screen G5 to an operation screen G6 (not shown).

Subsequently, differences between operation screen G6 and operation screen G3 will be described. Operation screen G6 is a screen corresponding to image object 506. Therefore, tablet terminal 3 highlights image object 506. Operation screen G6 is associated with position #4 of four positions #1 to #4. Operation screen G6 includes information for describing measurement at position #4, instead of information 531. The information includes a robot image showing position #4, and a descriptive text.

Also on operation screen G6, user 900 performs a series of operations shown in steps S1 to S11 of FIG. 7. Thereby, control unit 251 (specifically, current value acquisition unit 2511) of collaborative robot 2 acquires the current values of motors 271 to 275 and 276a at position #4 related to hand #1. Control unit 251 stores a measurement result of the current values in association with the information on position #4.

After removing the workpiece from hand #1, the user selects button 515 on operation screen G6. When button 515 is selected, tablet terminal 3 switches the operation screen from operation screen G6 to an operation screen G7.

### b5. Load Measurement

Upon acquiring the current values (measurement results) of motors 271 to 275, 276a, and 276b at four positions #1 to #4, collaborative robot 2 performs measurement (calculation) of a load (the workpiece in the present example) based on these current values. Specifically, load calculation unit 2512 of control unit 251 calculates the mass [kg] of the workpiece, the position of the center of gravity (X coordinate) [m] of the workpiece, the position of the center of gravity (Y coordinate) [m] of the workpiece, the position of the center of gravity (Z coordinate) [m] of the workpiece, the moment [Nm] about the fourth axis, the moment [Nm] about the fifth axis, the moment [Nm] about the sixth axis, the allowable value of the mass [kg] of the workpiece, the allowable value of the moment [Nm] about the fourth axis, the allowable value of the moment [Nm] about the fifth axis, the allowable value of the moment [Nm] about the sixth axis, and the like.

Upon completing the measurement of the load, collaborative robot 2 transmits the measurement results to tablet terminal 3. Thereby, tablet terminal 3 can acquire a result of the load measurement. It should be noted that collaborative robot 2 may transmit all of the measurement results to tablet terminal 3, or may transmit some of the measurement results to tablet terminal 3. In the present example, collaborative robot 2 transmits at least information on the mass of the workpiece, the position of the center of gravity (X coordinate) of the workpiece, the position of the center of gravity (Y coordinate) of the workpiece, and the position of the center of gravity (Z coordinate) of the workpiece, to tablet terminal 3.

### b6. Operation Screen G7

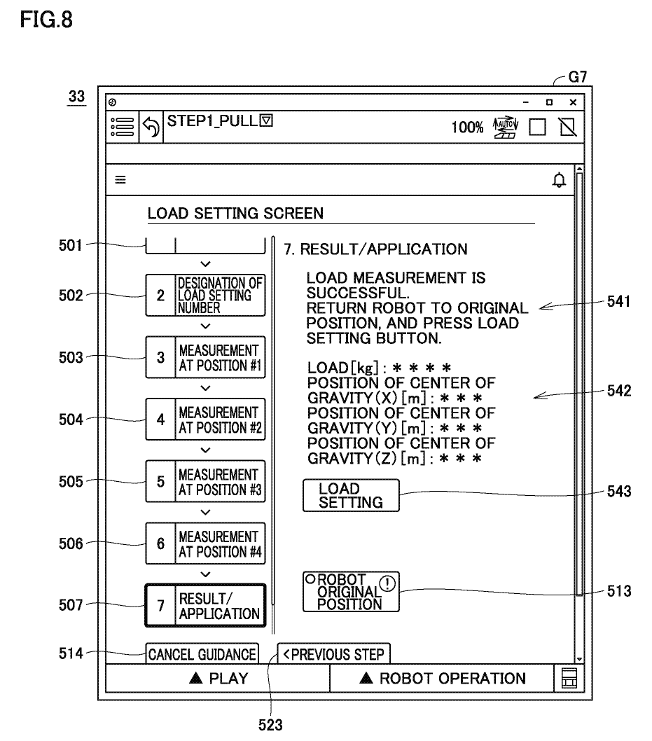

FIG. 8 is a diagram showing operation screen G7 displayed on tablet terminal 3.

As shown in FIG. 8, operation screen G7 includes image objects 501 to 507 arranged in one vertical line, as with other operation screens G1, G2, .... Operation screen G7 is a screen corresponding to image object 507. Therefore, tablet terminal 3 highlights image object 507.

Operation screen G7 further includes a descriptive text 541 describing an operation, information 542 on the load measured in collaborative robot 2, a button 543 for setting and registration, button 513 for automatically returning collaborative robot 2 to the original position, button 514 for selecting cancellation of guidance, and button 523 for returning to the previous step.

Descriptive text 541 indicates that the load measurement is successful. It should be noted that, when the load measurement fails in collaborative robot 2, this fact is displayed on operation screen G7. Information 542 on the load includes the mass of the workpiece, the position of the center of gravity (X coordinate) of the workpiece, the position of the center of gravity (Y coordinate) of the workpiece, and the position of the center of gravity (Z coordinate) of the workpiece. From information 542 on the load, user 900 can know the mass of the workpiece and the positions of the center of gravity of the workpiece.

As described in descriptive text 541, user 900 selects button 513 to return the position of collaborative robot 2 to the original position. Thereafter, user 900 selects button 543. By selection of button 543, tablet terminal 3 instructs collaborative robot 2 to set and register the result of the load measurement as a load during actual use.

Based on the instruction, collaborative robot 2 sets and registers the result of the load measurement. Thereby, collaborative robot 2 can calculate current values (theoretical values) of motors 271 to 275, 276a, and 276b at various positions including positions #1 to #4, during actual use. Accordingly, collaborative robot 2 can sense contact (collision) with an object such as a person, by comparing the current values obtained by calculation with actual current values, during actual use.

### b7. Operation Screen G8

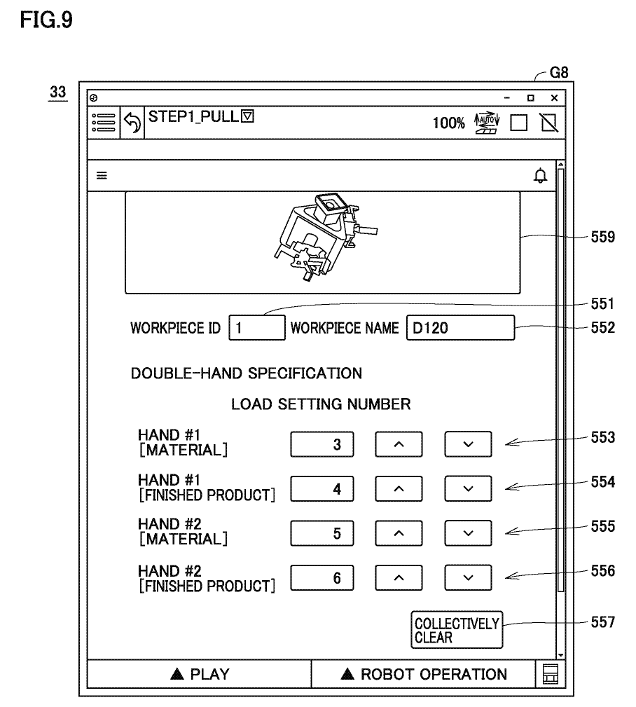

FIG. 9 is a diagram showing an operation screen G8 for changing a load setting number. As shown in FIG. 9, operation screen G8 includes an image 559 of end effector 290, an input field 551 for inputting identification information (ID) of a workpiece, and an input field 552 for entering the name of the workpiece.

Operation screen G8 further includes a setting field 553 for changing a load setting number when a workpiece (specifically, a material) is gripped by hand #1, and a setting field 554 for changing a load setting number when a workpiece (specifically, a finished product manufactured by processing the material) is gripped by hand #1. Operation screen G8 further includes a setting field 555 for changing a load setting number when a workpiece (material) is gripped by hand #2, and a setting field 556 for changing a load setting number when a workpiece (finished product) is gripped by hand #2. Operation screen G8 further includes a button 557 for collectively clearing settings displayed on operation screen G8.

With such operation screen G8, user 900 can easily change the identification information of the workpiece, the name of the workpiece, and each load setting number.

### b8. Additional Aspects

Button 536 is an example of the "first button" in the present disclosure. Buttons 532 to 535 and 537 are examples of the "second button" in the present disclosure. Button 538 is an example of the "third button" in the present disclosure. Buttons 515 and 523 are examples of the "fourth button" in the present disclosure. Button 543 is an example of the "fifth button" in the present disclosure.

Operation screens G3 to G6 are examples of the "first operation screen" in the present disclosure. Operation screen G2 is an example of a "second operation screen" in the present disclosure. Operation screen G7 is an example of a "third operation screen" in the present disclosure.

Image objects 503 to 506 are examples of a "first image object" in the present disclosure. Image object 502 is an example of a "second image object" in the present disclosure. Image object 507 is an example of a "third image object" in the present disclosure.

### C. Summary

Tablet terminal 3 will be summarized as below.

(1) Tablet terminal 3 supports load setting in collaborative robot 2 having a plurality of axes 231 to 235, 236a, and 236b driven by motors 271 to 275, 276a, and 276b different from each other. Tablet terminal 3 includes: display 331; display control unit 311 that causes display 331 to selectively display a plurality of operation screens G3 to G6 for the load setting; and communication unit 34 that communicates with collaborative robot 2.

Each of the plurality of operation screens G3 to G6 is associated with a corresponding one of a plurality of predetermined positions #1 to #4 of collaborative robot 2, the corresponding ones being different from each other. Each of operation screens G3 to G6 includes (i) button 536 for instructing collaborative robot 2, via communication unit 34, to transition to the position associated with the operation screen, (ii) buttons 532 to 535 and 537 for instructing collaborative robot 2, via communication unit 34, to open/close hands 291 and 292 that grip a workpiece, and (iii) button 538 for instructing collaborative robot 2, via communication unit 34, to measure current values of the motors.

With such a configuration, on operation screen G3 corresponding to position #1, user 900 can perform an operation of instructing collaborative robot 2 to transition to position #1, an operation of instructing collaborative robot 2 to open/close hands 291 and 292 in a state where collaborative robot 2 is at position #1, and an operation of instructing collaborative robot 2 to measure the current values of the motors in a state where collaborative robot 2 is at position #1. Similarly, user 900 can perform the above three operations similar to those for operation screen G3, on each of operation screen G4 corresponding to position #2, operation screen G5 corresponding to position #3, and operation screen G6 corresponding to position #4.

Accordingly, user 900 can instruct collaborative robot 2 to transition, to open/close the hands, and to measure the current values, on the same operation screen, for each of positions #1 to #4. Therefore, tablet terminal 3 can reduce time and effort for a user operation during the load setting, as compared with a configuration in which the user notifies collaborative robot 2 of a transition position, instructs collaborative robot 2 to open/close the hands, and instructs collaborative robot 2 to measure the current values, on different operation screens.

Furthermore, since it is possible to automatically transition the position of collaborative robot 2 by selecting button 536, collaborative robot 2 can transition to a target position quickly and accurately, as compared with a manual transition operation using a jog dial or the like, and a transition operation performed by directly moving collaborative robot 2 by hand.

(2) Each of operation screens G3 to G6 further includes buttons 515 and 523 for transitioning from the operation screen that is displayed (G3 to G6) to another operation screen that is hidden (G3 to G6).

With such a configuration, user 900 can transition the screen of tablet terminal 3 from a currently displayed operation screen to another operation screen, by operating each of the buttons on the currently displayed operation screen (G3 to G6).

(3) Collaborative robot 2 includes hand #1 and hand #2, as the hand. Each of operation screens G3 to G6 receives an input for designating the hand to be opened/closed, from among hand #1 and hand #2. With such a configuration, tablet terminal 3 can perform the load setting for each hand, even when end effector 290 of collaborative robot 2 has double hands.

(4) Display control unit 311 causes display 331 to display operation screen G2 that receives an input of a setting number for the load setting, before causing display 331 to display each of operation screens G3 to G6. With such a configuration, the load setting using each of operation screens G3 to G6 can be performed for each type of workpiece.

(5) When load measurement is performed in collaborative robot 2 based on measurement of the current values at all of the plurality of positions #1 to #4, display control unit 311 causes display 331 to display operation screen G7 including a result of the load measurement. With such a configuration, user 900 can know the result of the load measurement.

(6) When button 543 is selected on operation screen G7, tablet terminal 3 instructs collaborative robot 2 to set and register the result of the load measurement as a load during actual use. With such a configuration, user 900 can instruct collaborative robot 2 to set and register the result of the load measurement on operation screen G7 including the result of the load measurement.

(7) Operation screens G2 to G7 further include a plurality of image objects 503 to 506 individually showing an outline of each processing on operation screens G3 to G6, image object 502 showing an outline of processing on operation screen G2, and image object 507 showing an outline of processing on operation screen G7. Image objects 502 to 507 are arranged in one line in this order. Display control unit 311 changes a manner of display of an image object which is one of the plurality of image objects 502 to 507 and corresponds to an operation screen displayed on display 331 among the plurality of operation screens G2 to G7.

With such a configuration, user 900 can immediately grasp details of the processing being performed on a currently displayed operation screen, and a progress status of the processing for the load setting.

### D. Modifications

In the above description, the load setting is performed by measuring current values at four positions #1 to #4. However, the present invention is not limited thereto. For example, the load setting may be performed by measuring current values at three positions, or at five or more positions.

Although tablet terminal 3 has been described as an example of the information processing device, the present invention is not limited thereto. The information processing device may be a laptop computer, a smartphone, or the like. While the information processing device is not particularly limited, it is preferable from the viewpoint of convenience that the information processing device can be operated in the vicinity of collaborative robot 2.

### E. Additional Aspects

(1) An information processing device that supports load setting in a collaborative robot having a plurality of axes driven by motors different from each other includes: communication means for communicating with the collaborative robot; first instruction means for instructing the collaborative robot, via the communication means, to transition to a predetermined posture; second instruction means for instructing the collaborative robot, via the communication means, to open/close a hand that grips a workpiece; and third instruction means for instructing the collaborative robot, via the communication means, to measure current values of the motors.

(2) A collaborative robot includes: a hand that grips a workpiece; a plurality of axes including an axis that opens/closes the hand; a plurality of motors that individually drive the plurality of axes; a plurality of sensors that individually detect current values of currents flowing through the plurality of motors; control means for controlling the plurality of motors; and communication means for communicating with an information processing device. When the control means receives a first instruction from the information processing device via the communication means, the control means transitions a posture of the collaborative robot to a predetermined posture. When the control means receives a second instruction from the information processing device via the communication means, the control means opens/closes the hand. When the control means receives a third instruction from the information processing device via the communication means, the control means acquires the current values of the plurality of motors from the plurality of sensors.

Although the embodiment of the present invention has been described, it should be understood that the embodiment disclosed herein is illustrative and non-restrictive in every respect. The scope of the present invention is defined by the scope of the claims, and is intended to include any modifications within the scope and meaning equivalent to the scope of the claims.

What is claimed is:

1. An information processing device that supports load setting in a collaborative robot having a plurality of axes driven by motors different from each other, the information processing device comprising:
a display;
display control means for causing the display to selectively display a plurality of first operation screens for the load setting; and
communication means for communicating with the collaborative robot, wherein
each of the plurality of first operation screens is associated with a corresponding one of a plurality of predetermined postures of the collaborative robot, the corresponding ones being different from each other, and
each of the first operation screens includes
a first button for instructing the collaborative robot, via the communication means, to transition to the posture associated with the first operation screen,
a second button for instructing the collaborative robot, via the communication means, to open/close a hand that grips a workpiece, and
a third button for instructing the collaborative robot, via the communication means, to measure current values of the motors.

2. The information processing device according to claim 1, wherein each of the first operation screens further includes a fourth button for transitioning from the first operation screen that is displayed to another first operation screen that is hidden.

3. The information processing device according to claim 2, wherein
the collaborative robot includes a first hand and a second hand, as the hand, and
each of the first operation screens receives an input for designating the hand to be opened/closed, from among the first hand and the second hand.

4. The information processing device according to claim 1, wherein the display control means causes the display to display a second operation screen that receives an input of a setting number for the load setting, before causing the display to display each of the first operation screens.

5. The information processing device according to claim 4, wherein, when load measurement is performed in the collaborative robot based on measurement of the current values at all of the plurality of postures, the display control unit causes the display to display a third operation screen including a result of the load measurement.

6. The information processing device according to claim 5, wherein
the third operation screen includes a fifth button, and
when the fifth button is selected, the information processing device instructs the collaborative robot to set and register the result of the load measurement as a load during actual use.

7. An information processing device that supports load setting in a collaborative robot having a plurality of axes driven by motors different from each other, the information processing device comprising:
communication means for communicating with the collaborative robot;
first instruction means for instructing the collaborative robot, via the communication means, to transition to a predetermined posture;
second instruction means for instructing the collaborative robot, via the communication means, to open/close a hand that grips a workpiece; and
third instruction means for instructing the collaborative robot, via the communication means, to measure current values of the motors.

8. A collaborative robot comprising:
a hand that grips a workpiece;
a plurality of axes including an axis that opens/closes the hand;
a plurality of motors that individually drive the plurality of axes;
a plurality of sensors that individually detect current values of currents flowing through the plurality of motors;
control means for controlling the plurality of motors; and
communication means for communicating with an information processing device, wherein
when the control means receives a first instruction from the information processing device via the communication means, the control means transitions a posture of the collaborative robot to a predetermined posture,
when the control means receives a second instruction from the information processing device via the communication means, the control means opens/closes the hand, and
when the control means receives a third instruction from the information processing device via the communication means, the control means acquires the current values of the plurality of motors from the plurality of sensors.

9. A method for supporting load setting in a collaborative robot having a plurality of axes driven by motors different from each other, the method comprising:
selectively displaying a plurality of operation screens for the load setting;
communicating with the collaborative robot,
each of the plurality of operation screens being associated with a corresponding one of a plurality of predetermined postures of the collaborative robot, the corresponding ones being different from each other,
each of the operation screens including a first button for instructing the collaborative robot to transition to the posture associated with the operation screen, a second button for instructing the collaborative robot to open/close a hand that grips a workpiece, and a third button for instructing the collaborative robot to measure current values of the motors; and
receiving selection of the first to third buttons on each of the operation screens.
